(19) United States
(12) Patent Application Publication
(10) Pub. No.: US 2010/0284887 A1
(43) Pub. Date: Nov. 11, 2010

(54) METHOD AND DEVICE FOR PRODUCING SILICON

(76) Inventor: Jan-Philipp Mai, Braunschweig (DE)

Correspondence Address: SALTER & MICHAELSON;THE HERITAGE BUILDING, 321 SOUTH MAIN STREET, PROVIDENCE, RI, 029037128, US

(21) Appl. No.: 12/682,917

(22) PCT Filed: Oct. 17, 2008
(86) PCT No.: PCT/EP2008/064034

§ 371 Date: Jun. 16, 2010

(30) Foreign Application Priority Data
Oct. 17, 2007 (DE) 10 2007 050 010.8

(51) Int. Cl. C01B 33/025; B01J 19/08

(52) U.S. Cl. 423/350; 422/186

(57) ABSTRACT

A method for producing silicon by the thermal reduction of a starting material based on silicon dioxide using a reducing agent in a microwave oven.

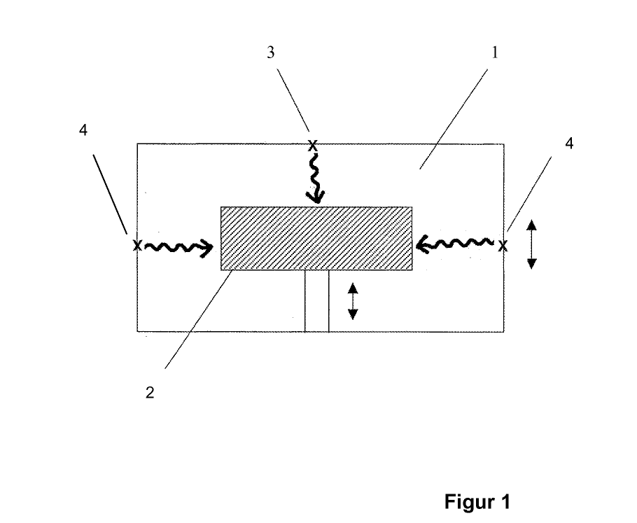

The present invention relates to a method for producing silicon especially ultra pure silicon such as is needed for the production of semiconductors and solar cells, and also to a device for this purpose.

For use in these fields, one requires silicon the degree of impurity of which is extremely small or is precisely controlled. In addition, the manufacturing process should be economical.

Various methods for the production of ultra pure silicon are known.

In one approach, metallurgical silicon which has been obtained from quartz sand in a blast furnace process is used as the starting material. The metallurgical silicon is then converted into ultra pure polycrystalline silicon utilising a multi-stage process based on trichlorosilane. Here, the metallurgical silicon is converted into trichlorosilane using silicon tetrachloride and hydrogen and is obtained from the trichlorosilane by a process of disproportionating silane tetrachloride and silane. From the silane formed thereby, ultra pure silicon is then obtained on silicon rods by means of a thermal decomposition process.

In accordance with another approach, silicon is obtained from quartz or quartz glass by a reduction process. One example of this is a so-called carbothermic reduction process wherein carbon is used as a reducing agent. A feature common to these reductive methods is that the starting material for the conversion process must be in the molten state which is an energy-intensive process.

Thus, it is known to effect the smelting process in an arc furnace. But there is a disadvantage here in that the electrodes employed in an arc furnace are subject to wear-and-tear and in addition, there is a danger of the electrodes being contaminated by the reducing agent such as carbon.

Consequently, there is a need for a method by means of which silicon can be obtained from a readily accessible raw material in a simple and energy-propitious manner.

The method in accordance with the invention is founded on the second approach which is based on producing silicon by a reductive process.

In accordance with the invention, a method for producing silicon is provided by a process involving the reductive conversion of a starting material based on silicon dioxide using a reducing agent, wherein the starting material based on silicon dioxide together with the reducing agent are converted in a microwave oven.

The starting material based on silicon dioxide which is utilised in accordance with the invention can be quartz sand, quartz or glass.

The glass may be quartz glass, i.e. a glass consisting of 100% SiO₂, or quartz glass to which suitable doping elements have been added in dependence on the usage. Whenever possible, use is advantageously made of a starting material the composition of which corresponds to the requirements of the subsequent field of application, for example, in regard to the type and quantity of the doping elements. In this way, the outlay required for any possibly needed refining of the silicon thereby obtained can be avoided or at least reduced.

For the method in accordance with the invention, the starting material based on silicon dioxide is ground and then used in the form of a powder for example. A suitable powder-like starting material is quartz powder for example.

For the reduction process, use can be made of a reducing agent such as is known for producing silicon by means of a thermal reduction process.

Examples of such agents are carbon-based reducing agents such as carbon powders, graphite powders or a mixture consisting of carbon powder and graphite powder, or aluminium, magnesium etc. Preferably in accordance with the invention, the reduction is effected by means of a carbo-thermic process, i.e. using reducing agents based on carbon.

Heating in a microwave oven is effected by exposing the material requiring heating to electromagnetic radiation. To this end, the reaction mixture consisting of the starting material and a reducing agent is placed in a suitable reaction vessel. This reaction vessel can consist of a material which is transparent to the working frequency of the microwave oven being employed.

Alternatively, a container could also be used which consists of a material that is not transparent or is only partially transparent to the working frequency of the microwave oven being employed. In this case, the container is also heated so that the heating and smelting processes are assisted by thermal conduction from the material of the container into the mixture requiring conversion.

Consequently, the material of the container is no longer critical so long as it is transparent to the microwaves or enables the mixture requiring conversion to be heated to the right extent by means of a thermal conduction process.

Advantageously for the method in accordance with the invention, use can be made of microwave ovens which work at a frequency such as that utilised in conventional domestic microwave ovens. These use electromagnetic radiation having a frequency of typically about 2.455 GHz.

Since in principle in accordance with the invention, microwave ovens can be used such as are commercially and economically available, the method in accordance with the invention is distinguished in particular by virtue of its easily operable apparatus.

Preferably, microwave ovens incorporating a power regulator and in particular a continuous power regulator are used so that, for example, the irradiation produced by the microwaves can be adjusted and regulated as required. The use of power-regulated microwave ovens is a further contribution to the conservation of energy.

For the purposes of producing the silicon, the starting material based on silicon dioxide is finely ground and mixed with the reducing agent.

The mixture obtained thereby is placed in a container and the starting material based on silicon dioxide is heated and melted by the effect of the microwaves, whereby the reduction process is effected by the reducing agent.

The conversion process is preferably effected in an inert gas atmosphere such as nitrogen or argon or in a vacuum for example, in order to prevent any possible reaction of the resultant silicon with atmospheric oxygen.

The direction of irradiation of the electromagnetic radiation can, in principle, be selected at will as long as the starting material is heated to a sufficient extent as to melt it.

The accompanying FIGURE schematically depicts a device for a preferred embodiment in accordance with the invention, whereby the device also forms subject-matter of the invention.

In accordance with the preferred embodiment illustrated in the FIGURE, the thermal reduction of the starting material in combination with a purification process can be accomplished using the principle of a zone melting process.

Hereby, a zone of the body of material that is to be purified is melted and the molten zone is passed through the body of material. The impurities collect at the front of the advancing molten zone. The zone melting process can be effected horizontally or vertically.

For the purposes of carrying out the zone melting process, the reaction product, which consists substantially of silicon, is melted in zone-like manner with the help of the microwave irradiation.

Silicon itself cannot be directly affected and thereby heated by microwaves. In this case, as the silicon cannot be adequately heated directly by the microwave irradiation, use is made of a container which consists of a material that is affected by and heated up by the frequency of the electromagnetic radiation in the microwave oven being employed. Hereby, the heating and melting of the silicon is effected by a process of thermal conduction from the wall of the container into the silicon.

Consequently, the material of the container must be selected with regard to the working frequency of the microwave oven being employed. Examples of suitable materials for the container in the case of commercial microwave ovens are graphite, silicon carbide etc. These materials readily absorb energy and hence there is adequate heating of the silicon when they are exposed to the electromagnetic radiation of about 2.455 GHz in commercial microwave ovens.

The region of irradiation or input of heat and thus the molten front can be guided vertically, i.e. perpendicularly to the surface of the resultant reaction product, or horizontally, i.e. parallel to the surface of the resultant reaction product.

For the purposes of guiding the molten front in the desired direction, means are provided for the guidance of the radiation front 4. For example, the corresponding microwave sources or the container 2 or both the container 2 and the microwave sources can be implemented such as to be moveable. Advantageously, the microwave sources are positioned in such a way that the field maxima of the irradiating microwaves are produced within the regions of the reaction product that require heating.

In accordance with a preferred embodiment, the container 2 is implemented such that it is moveable in both the vertical and the horizontal directions.

In the FIGURE, there is shown in exemplary manner, an arrangement for a method in accordance with the invention using vertical zone melting.

For the purposes of carrying out the zone melting process here, the container 2 containing the reaction product is exposed laterally to the electromagnetic radiation.

The direction of motion of the radiation front 4 or of the container 2 for the zone melting process is schematically represented by arrows.

If the process for the conversion into silicon is combined with a zone melting process, it has proved advantageous to employ a separate radiation source 3 for melting the starting material based on silicon dioxide and its conversion with the aid of the reducing agent, said source irradiating the starting material from above or else from below.

In accordance with the invention, it is preferred that quartz glass, which may be appropriately doped, be ground, mixed with the likewise finely ground reducing agent and inserted into a container.

The container can be placed in a conventional commercially available microwave and the starting material then melted therein by an irradiation process and converted to silicon with the aid of the reducing agent.

In accordance with the invention, a plurality of preferably moveable containers can also be placed in the microwave oven at the same time depending upon the particular arrangement.

In accordance with a preferred embodiment, the reaction mixture consisting of the starting material and a reducing agent is pre-heated prior to the thermal reduction process.

Preferably, it is pre-heated to a temperature in the region of 500° C.

The pre-heating process is preferably effected within the microwave in order to prevent any possible combustion of the reducing agent.

By virtue of this preceding heating of the reaction mixture, the amount of energy that is required for the thermal reduction process can be reduced.

Furthermore, it has been shown that the simultaneous application of additional heating during and after the reaction process serves to assist the further-processing of the resultant reaction product. In addition, better absorption of the microwaves can be observed when simultaneously applying additional heating.

This means that the microwave power can be reduced. A heating device which is different from the source of microwaves can be provided in the microwave oven for the heating process. A conventional and known heating device can be provided in the microwave oven for this purpose. An induction heating arrangement is particularly suitable.

For the purposes of preventing any possible contamination, the starting material and the products should be kept in an inert gas until they have cooled to room temperature.

With the aid of the method in accordance with the invention, ultra pure silicon can be obtained by a reductive conversion process based upon commercially available microwave ovens in a simple and energy-efficient manner.

### LIST OF REFERENCE SYMBOLS

1 microwave oven
2 container for holding the starting material and a reducing agent
3 radiation source for the melting process
4 radiation front in the zone melting process
[symbol] Direction of motion of the container and/or the radiation front in the zone melting process

1. A method for producing silicon by thermal reduction of a starting material based on silicon dioxide using a reducing agent in a microwave oven.

2. A method in accordance with claim 1, characterized in that the starting material based on silicon dioxide is selected from quartz, quartz glass and doped quartz glass.

3. A method in accordance with claim 1, characterized in that a reducing agent based on carbon is used.

4. A method in accordance with claim 3, characterized in that carbon powder, graphite powder or a mixture thereof is used as the reducing agent.

5. A method in accordance with claim 1, characterized in that the silicon obtained is additionally submitted to a zone melting process in the microwave oven.

6. A method in accordance with claim 1, characterized in that the reaction mixture including the starting material and the reducing agent is pre-heated prior to the thermal reduction process.

7. A method in accordance with claim 1, characterized in that the thermal reduction process is carried out whilst simultaneously applying additional heat to the reaction mixture including the starting material and the reducing agent.

8. A method in accordance with claim 1, characterized in that the reaction product obtained is heated or kept warm after the thermal reduction process.

9. A method in accordance with claim 8, characterized in that the heating process is effected inductively.

10. A device for producing silicon by thermal reduction of a starting material based on silicon dioxide using a reducing agent, wherein the device is a microwave oven and is provided for holding at least one container, wherein sources of microwaves are provided for producing a radiation front for the purposes of carrying out a zone melting process.

11. A device in accordance with claim 10, wherein the at least one container is constructed of a material which is not transparent to the working frequency of the microwave source being employed and is heated by the microwaves.

12. A device in accordance with claim 10, wherein means are provided for the vertical or horizontal guidance of the radiation front.

13. A device in accordance with claim 12, wherein the means are selected from at least one moveably arranged source of microwaves, at least one moveably arranged container and a combination thereof for the purposes of producing a moveable radiation front.

14. A device in accordance with claim 13, wherein the at least one container is moveable in the vertical and horizontal directions.

15. A device in accordance with claim 14, wherein there is additionally provided a different heating device from the source of microwaves.

16. A device in accordance with claim 14, wherein the additional heating device is an inductive heating device.

17. Use of a microwave oven for the thermal reduction of a starting material based on silicon dioxide to silicon utilising a reducing agent.
